(19) United States
(12) Patent Application Publication
(10) Pub. No.: US 2026/0266249 A1
(43) Pub. Date: Sep. 10, 2026

(54) INTAKE TEMPERATURE MANAGEMENT SYSTEMS FOR COMPRESSION IGNITION OF SMALL MOLECULE FUELS

(71) Applicant: Climate Energy Investments, LLC, Los Altos, CA (US)

(72) Inventors: Julie BLUMREITER, Batavia, IL (US); Robert SCHANZ, Aurora, IL (US); Bernard Henry JOHNSON, IV, Los Altos, CA (US); Peter V. WOON, Columbus, IN (US); Manohar VITTAL, Naperville, IL (US); Jeremy BABINET, Geneva, IL (US); Craig BARNES, Columbus, IN (US); Jim CLERC, Columbus, IN (US); Greg HENDERSON, Columbus, IN (US); Cody WOLFE, Columbus, IN (US); Brandon BARNGROVER, Columbus, IN (US)

(21) Appl. No.: 19/354,536

(22) Filed: Oct. 9, 2025

Related U.S. Application Data
(63) Continuation of application No. 19/061,604, filed on Feb. 24, 2025, now abandoned.
Application No. 19/061,604 is a continuation of application No. PCT/US2023/072840, filed on Aug. 24, 2023.
(60) Provisional application No. 63/400,653, filed on Aug. 24, 2022.

(51) Int. Cl. F02M 31/04; F02D 41/00; F02M 26/00; F02M 26/01; F02M 26/04; F02M 26/22; F02M 31/20

(52) U.S. Cl. CPC F02M 31/042; F02D 41/0087; F02M 26/01; F02M 26/04; F02M 26/22; F02M 31/205; F02M 2026/004

(57) ABSTRACT

Embodiments described herein relate to systems and methods of managing intake temperature of intake gases in internal combustion engines to enable autoignition of small-molecule low-cetane fuels. In some aspects, a method of operating a compression ignition engine can include moving a volume of air through a first flow path, closing a first valve to prevent the volume of air from entering a charge air cooler (CAC), opening a second valve to guide the volume of air to a second flow path, the second flow path including a heating unit, and moving the volume of air to an intake manifold. In some embodiments, the method can further include applying heat via the heating unit to the volume of air while the volume of air moves through the second flow path.

### CROSS-REFERENCE TO RELATED APPLICATIONS

This application is a continuation of U.S. application Ser. No. 19/061,604, filed Feb. 24, 2025, which is a continuation of International Application No. PCT/US2023/072840, filed Aug. 24, 2023, which claims priority and benefit of U.S. Provisional Application No. 63/400,653, filed Aug. 24, 2022, and entitled “Intake Temperature Management Systems for Compression Ignition of Small Molecule Fuels,” the disclosures of each of which are hereby incorporated by reference herein in their entireties.

### TECHNICAL FIELD

Embodiments described herein relate to intake temperature management systems for compression ignition of small molecule fuels, and methods of operating the same.

### BACKGROUND

Burning ethanol, methanol, and other low cetane, small-molecule fuels in a mixing-controlled compression ignition (MCCI) engine requires significantly higher temperature to start combustion than diesel and other readily igniting traditional MCCI fuels. One method to achieve sufficiently high temperatures to ignite these fuels is to increase the temperature of the incoming gases. Incoming gases are typically air and/or recirculated exhaust and are collectively referred to as ‘charge’—those gases which are brought in during the engine's intake stroke. Another method to achieve sufficiently high temperatures is to retain hot gases in the cylinder for the next combustion event. Both methods achieve sufficiently high combustion temperatures by managing in-cylinder temperatures at intake valve closing. Targeting a temperature at intake valve closing (IVC) instead of pre-injection temperature makes this distinct from some early-firing prechamber concepts.

### SUMMARY

Embodiments described herein relate to systems and methods of managing intake temperature of intake gases and cylinder temperature at intake valve closing (IVC) in internal combustion engines. In some aspects, a method of operating a compression ignition engine can include moving a volume of air through a first flow path, closing a first valve to restrict the volume of air from flowing through a charge air cooler (CAC) bypass, opening a second valve to guide the volume of air to a second flow path, and moving the volume of air from both paths to an intake manifold. In some embodiments, one flow path can include a heating unit. In some embodiments, the method can further include applying heat via the heating unit to the volume of air. In some embodiments, the method can further include moving the exhaust gas through a turbocharger turbine to drive a compressor to compress the volume of air. In some embodiments, the method can include moving the volume of air into a plurality of combustion chambers via the intake manifold and combusting a small-molecule fuel in the plurality of cylinders while the volume of air is inside the plurality of cylinders to form a volume of combustion product.

### BRIEF DESCRIPTION OF THE DRAWINGS

FIG. 1 is a block diagram of an engine with an intake temperature management system, according to an embodiment.

FIG. 2 is a block diagram of a method of operating an engine with an intake temperature management system, according to an embodiment.

FIGS. 3A-3B are illustrations of an engine with an intake temperature management system, according to an embodiment.

FIG. 4 is an illustration of an engine with an intake temperature management system, according to an embodiment.

FIG. 5 is an illustration of a series of flow paths of an engine with an intake temperature management system, according to an embodiment.

FIG. 6 is an illustration of an intake heater, according to an embodiment.

FIG. 7 is an illustration of an engine with an intake temperature management system, according to an embodiment.

### DETAILED DESCRIPTION

Embodiments described herein integrate CAC bypass, exhaust gas recirculation, (EGR) cooler bypass, external heating, and internal heat retention to raise intake valve closing temperatures during engine operation as well as during engine start. The use of small-molecule fuels for compression ignition with hot intake-valve-closing temperatures of around 150° C. can be managed by using thermal flows already available in the engine (e.g., by reduced cooling of flows like the exhaust, or retaining heat to preserve compressor-out temperature) supplemented by heating devices in the intake path.

Embodiments described herein integrate targeted heating mechanisms to achieve scalable and stable temperature control of the intake charge from system level considerations. Embodiments described herein can also reduce heat rejection from the engine. Embodiments described herein can also combine with and transition from internal heat retention to external heat addition. Embodiments described herein can be used for temperature control during sustained engine operation as well as during engine starting. At the same time, embodiments described herein have the advantages of better packaging and lower pressure loss.

Embodiments described herein provide modular design configurations independent of various installation space, orientation, engine types, number of cylinders, engine geometry (inline or V shape) and power ranges. The concept, assembly, and geometrical layouts of CAC bypass, EGR cooler bypass, and air and EGR routing, in combination with external heating mechanisms provide new intake temperature control solutions to the engine.

Examples of thermal management systems used in compression ignition engines can be found in U.S. Pat. No. 9,903,262 (“the '262 patent”), filed Apr. 6, 2015, entitled “STOICHIOMETRIC HIGH-TEMPERATURE DIRECT-INJECTION COMPRESSION-IGNITION ENGINE,” International Patent Application No. PCT/US2020/032961 (“the '961 application”), filed May 14, 2020, entitled “COLD START FOR HIGH-OCTANE FUELS IN A DIESEL ENGINE ARCHITECTURE,” and U.S. Pat. No. 11,428,186 (“the '186 patent”), filed Sep. 16, 2021, entitled “FUEL AGNOSTIC COMPRESSION IGNITION ENGINE,” the disclosures of which are hereby incorporated by reference in their entireties.

Embodiments described herein relate to various engine architectures and are not limited to the four-stroke architecture most commonly used in on-road applications. The routing of air and fuel and adjusted thermal management can be applied to two-stroke, four-stroke, six-stroke, opposed piston, free piston, over-expanded (Atkinson or other) and/or rotary (Wankel or other) engine types.

Air cooler bypass routes have been included in diesel engines for partial air flow to bypass air cooler under low temperature engine conditions. Gasoline engines can include bypass valves along with an engine throttle valve to bypass air cooling for low load conditions. Under high load conditions, the bypass valve is closed, and air is cooled by a CAC upstream of the intake manifold. Instead of a bypass valve, a fixed valve was employed to control EGR and charge air flow rate during idle conditions when the throttle valve is closed. To control intake manifold water condensations, CAC bypass and EGR bypass have been employed. Three flow routes including CAC, CAC bypass and a separate bypass heater have been employed for a natural gas combustion engine; 4 valves were introduced to enable independent operations of three flow routes. Such a layout provides flexibility of bypass heating in balancing between pressure loss and heating power.

Embodiments described herein relate to novel hardware architectures and control schemes to provide sufficiently high IVC gas temperatures for low cetane fuels to operate in MCCI engines. As a sample case for this disclosure, a minimum IVC temperature of approximately 150° C. should be maintained for stable combustion for an ethanol fueled engine with a compression ratio of 18:1. This temperature can be attained by maintaining a minimum temperature of the incoming charge of approximately 120-130° C. with a fully warm engine running above approximately 25% load. At lower engine temperatures, as during warm-up, a higher minimum charge temperature may be needed to reach the same IVC temperature. As engine load increases, a lower minimum charge temperature may be needed.

Embodiments described herein relate to methods of equipping an engine to achieve required ignition temperatures and adjust those temperature-augmenting devices to maintain a desired temperature across engine operating conditions including cold start, extended idle, and high load operation. Several scenarios presenting problem areas for IVC thermal management are described herein, as well as descriptions of how the embodiments described herein address each problem.

Several scenarios present problems for compression ignition engines which can also affect maintaining a desired IVC temperature. For example, the engine can have difficulty cranking or starting before it is fully warmed up. If the IVC temperature control strategy relies on hot exhaust, the engine can have difficulty switching from motoring downhill (when hot exhaust would typically not be available) to accelerating uphill. The engine can have difficulty maintaining a high enough temperature to ignite small molecule or low-cetane fuels when operating at light load conditions. Extreme examples of light load conditions include extended idle periods, particularly overnight or waiting for a delivery. In some cases, the same thermal management systems described herein for these colder challenge areas can also accommodate operating schemes on the entire operating map of the engine. Thus, a thermal management system should be able to target the desired intake valve closing temperature at different speeds, loads, altitudes, and ambient conditions to allow for stable and robust MCCI of low-cetane or small-molecule fuels.

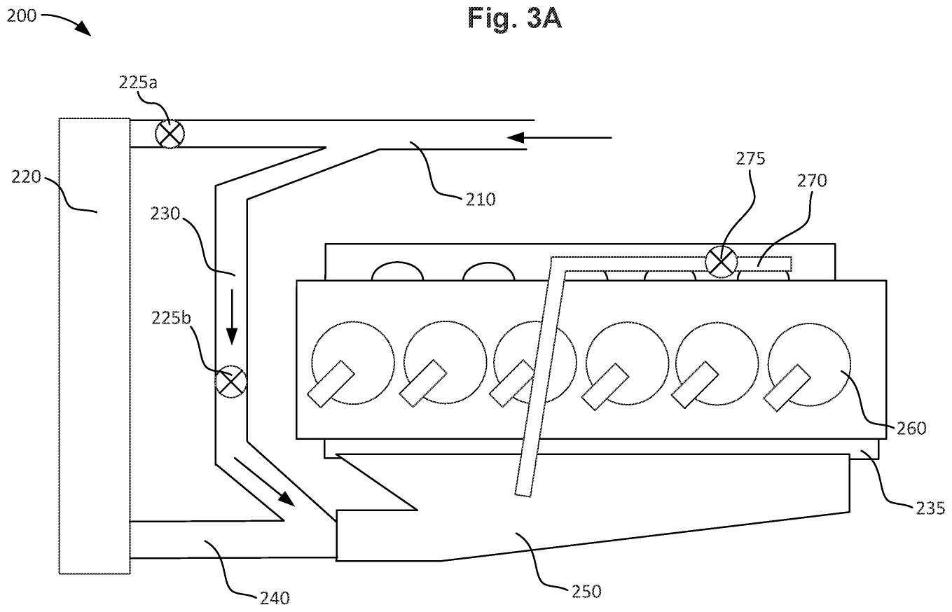

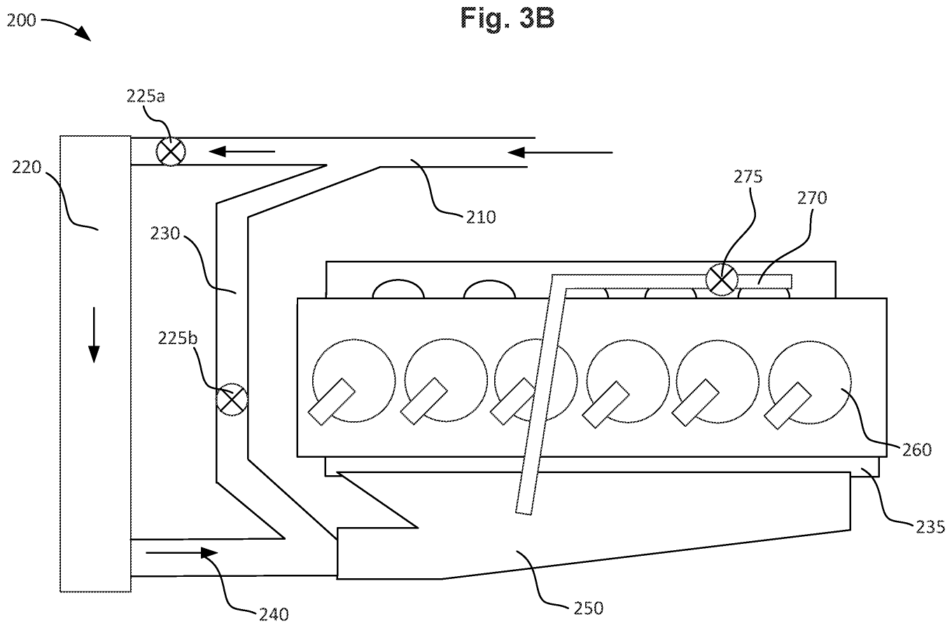

The thermal management challenge when cranking or starting at low temperatures is that exhaust heat as well as coolant and oil temperatures are not available to support reaching a target elevated IVC temperature. In some cases, a heat source or intake heating device can be used to pre-heat intake air prior to engine startup. The preheat time (time from activation of heating device to cranking the engine) can be a function of engine temperature and ambient temperature. Multiple heating devices can be employed with different preheat times. The heater can be an electric grid heater in the path of the intake air (e.g., see FIGS. 3A and 3B between the intake manifold and cylinder head). The heater can also include a heat exchanger with a hot fluid, a fuel-based heating device such as a burner, or other method to add heat to the charge prior to intake valve closing. After the preheat period, the engine is cranked.

To accomplish an effective and robust engine start of a low-cetane or small molecule fuel in an MCCI combustion mode, additional benefit can be derived from cranking the engine with the EGR valve(s) fully or nearly fully closed and the variable geometry (VG) turbo nearly fully closed. The exhaust restriction created by the EGR valve and VG turbo could also be created by a turbo-compounding device, an orifice plate, or other adjustable exhaust path restrictions. This combination causes high residual (exhaust) mass to retain heat and achieve a target IVC temperature for the following cycle as the engine begins to fire, with initial cycles IVC temperature reached from the warm air coming from the heating device. The closed or nearly closed EGR valve and nearly closed VG turbo also cause a relatively low mass flowrate of fresh inlet air, as the exhaust flow is restricted, which allows for higher temperature rise across the intake heater(s). For the same thermal energy input a lower mass flowrate of air receiving that heat will have a higher temperature than if a greater mass flowrate of air were receiving the same amount of thermal energy. During this initial startup period, providing additional fueling is also beneficial for a smooth and robust start, to make up for the extra pumping work to move the charge through the engine with the exhaust restriction. This additionally serves to further increase the in-cylinder and exhaust temperatures. The engine can reach idle and sustain operation in this mode as coolant, oil and metal temperatures rise.

As engine temperature increases, actuator positions on air, exhaust, turbocharger, and heating devices can be adjusted to maintain IVC temperature—either adding additional heat or trapping additional residual burned combustion products in the cylinder. One effective strategy can be summarized as follows: As temperatures rise, the EGR circuit can be slowly opened to bring hot gases into the intake manifold and replace the need for the supplemental heating of the intake within the first few minutes of engine operation. During this time, the CAC is also bypassed, so that the temperature rise through the compressor is maintained as air progresses into the intake manifold.

Some embodiments described herein address the scenario in which the engine has difficulty cranking or starting. These embodiments can include combining a unique blend of heaters, hot EGR gas introduction, hot residual gas retention via closing the variable geometry (VG) turbo (or other exhaust restriction), and elevated engine fueling to further raise exhaust and in-cylinder temperatures and manage the transitions in control modes seamlessly to the vehicle operator.

Regarding the switch from downhill to uphill, the engine would need to transition from motoring downhill (where no fuel is injected and the engine combustion chamber temperatures gradually drop) to accelerating uphill, where a cooler engine may not be conducive to high IVC temperatures needed for igniting small molecule fuels with smooth operation. The problem can be solved by monitoring conditions at intake valve closing and adding sufficient heat to the charge air to stay above the flammability limit for the fuel being used (e.g., a low-cetane fuel). One way to accomplish this is by limiting total air flow via closing the VG turbo, recirculating air expelled by the engine back to the intake manifold via the EGR loop, adding heat to the intake charge, if needed, and/or keeping the charge air cooler bypassed to avoid cooling the air that is boosted by the closed VG turbo. Since this closed loop of recirculating air or air and exhaust keeps temperatures high, fuel can be added quickly when desired as the vehicle needs to climb the next hill. After fuel is added, the EGR valve can be quickly partially closed and VG partially opened to bring sufficient fresh air into the engine for combustion.

Regarding operating at high temperatures, where short or long-term operation at light load is required, high amounts of uncooled EGR can be applied to keep the excess air ratio (λ) as low as about 1.1 to about 1.2, where exhaust temperatures can stay very high and recirculated exhaust gases warm the intake charge sufficiently to keep IVC temperatures above the minimum to sustain combustion.

Diagrams of the engine architectures that accomplish the above are shown in the figures. For example, FIGS. 3A-3B show an engine with an adjustable bypass path around the engine's charge air cooler and a system for bringing uncooled EGR into the intake manifold. An EGR control valve is used to modulate EGR flow rate to intake. In some embodiments, an EGR cooler may be employed on the engine and the uncooled EGR is accomplished by bypassing the cooler on an adjustable or partial basis or controlling hot and cold EGR loops according to a desired target IVC temperature.

Approaches used the scenarios described above can be used in concert with each other across the various engine conditions where additional heat may be needed to accomplish an intake valve closing temperature of at least about 150° C.

In either of the scenarios noted above, cycling the intake charge through the engine repeatedly by recirculating a majority through an open hot EGR or CAC bypass loop can enable heating mechanisms in the intake path to be more effective, since the gases can pass by and interact with them more than once. One example can include leaving an EGR valve open, closing or mostly closing the VG turbo, operating an intake heater, and (with or without injecting fuel) recirculating the majority of charge so it can gain additional heat from passing through the heater subsequent times to build sufficient heat to light off a low-cetane fuel. The compression process in some cases will also add additional heat to the air, reinforcing the increase in temperature from passing it through the engine multiple times.

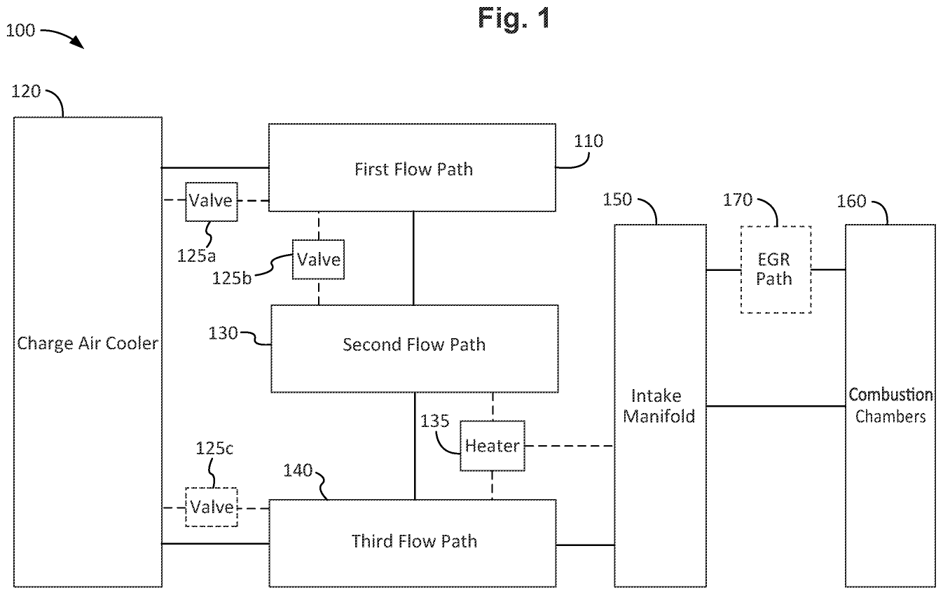

FIG. 1 is a block diagram of an engine 100 with an intake temperature management system, according to an embodiment. As shown, the engine 100 includes a first flow path 110, a charge air cooler (CAC) 120, valves 125a, 125b, 125c (collectively referred to as valves 125), a second flow path 130, a heater 135, a third flow path 140, an intake manifold 150, combustion chambers 160, and optionally an EGR bypass 170.

In use, a volume of intake gas flows through the first flow path 110. From the first flow path 110, the volume of intake gas can split between multiple paths—all or part of the flow passing through the CAC and the remainder passing through the second flow path, the fraction taking each path determined by position of valve 125b, or positions of valves 125b and 125c. From the CAC 120, the volume of intake gas can flow through valve 125c to the third flow path 140 where it combines with flow that flows through the second flow path 130. Valve 125a can be used in combination with valve 125b to accomplish a similar effect. Either combination of two valves listed (125a and 125b or 125b and 125c) can be used in combination to throttle the intake, reducing the pressure in the third flow path 140 and intake manifold 150. The volume of intake gas from both paths combined (the CAC 120 and the second flow path 130) can flow to the third flow path 140. The volume of intake gas then flows to the combustion chambers 160 via the intake manifold 150. The heater 135 can be in contact with the second flow path 130, the third flow path 140, and/or the intake manifold 150.

In some embodiments, the engine 100 can include a four-stroke engine. In some embodiments, the engine 100 can include a two-stroke engine. In some embodiments, the engine 100 can include a five-stroke engine. In some embodiments, the engine 100 can include a six-stroke engine. In some embodiments, the engine 100 can include a free-piston engine. In some embodiments, the engine 100 can include an opposed piston engine. In some embodiments, engine 100 can include a rotary engine. In some embodiments, the engine 100 can include a Wankel rotary engine.

The first flow path 110 guides the volume of intake air. The flow path 110 is fluidically coupled to the CAC 120 via the valve 125a and the second flow path 130 via the valve 125b. The valves 125a, 125b can guide the volume of intake air to the CAC 120 and/or the second flow path 130. In some embodiments, the valves 125a, 125b can guide the movement of the volume of intake in various partition ratios between the CAC 120 and the second flow path 130.

In some embodiments, the volumetric percentage of the volume of intake gas passing through the CAC 120 can be at least about 0%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%. In some embodiments, the volumetric percentage of the volume of intake gas passing through the CAC 120 can be no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, or no more than about 5%. Combinations of the above-referenced volumetric percentages are also possible (e.g., at least about 0% and no more than about 100% or at least about 30% and no more than about 70%), inclusive of all values and ranges therebetween. In some embodiments, the volumetric percentage of the volume of intake gas fed to the CAC 120 can be about 0%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%.

In some embodiments, the first flow path 110 can include a tube. In some embodiments, the first flow path 110 can be composed of an iron-based alloy, structural steel, stainless steel, aluminized steel, an iron-based sintered metal, a cast iron alloy, an aluminum alloy, or any combination thereof. In some embodiments, the first flow path 110 can have a circular cross section. In some embodiments, the first flow path 110 can include an elliptical cross section. In some embodiments, the first flow path 110 can include an irregular-shaped cross section.

The CAC 120 cools the volume of intake gas as the volume of intake gas passes through the CAC 120. In some embodiments, the CAC 120 can include an air to air heat exchanger, a jacket water aftercooler, a welded-tube charge-air cooler, a heavy duty welded-tube charge air cooler, a bar-plate charge air cooler, a liquid cooled charge-air cooler, a bar-plate liquid cooled charge-air cooler, a round-tube plate fin liquid cooled charge-air cooler, or any combination thereof.

The valve 125a regulates the flow of the intake gas between the first flow path 110 and the CAC 120. In some embodiments, the valve 125a can be partially opened to partition intake gas between the CAC 120 and the second flow path 130. In some embodiments, the valve 125a can include a ball valve, a solenoid valve, a pneumatic valve, a needle valve, an air actuated axial valve, or any combination thereof. In some embodiments, the valve 125a can be used as a throttle valve.

The valve 125b regulates movement of the intake gas between the first flow path 110 and the second flow path 130. In some embodiments, the valve 125b can be partially open to partition the flow of intake gas between the CAC 120 and the second flow path 130. In some embodiments, the valve 125b can be used as a throttle valve.

The second flow path 130 can act as a CAC 120 bypass. The second flow path 130 connects the first flow path 110 and the third flow path 140. In some embodiments, the second flow path 130 can have similar dimensions or diameters to the first flow path 110. In some embodiments, the second flow path 130 can run parallel or approximately parallel to the CAC 120.

The valve 125c regulates movement of the intake gas between the CAC 120 and the third flow path 140. In some embodiments, the valve 125c can act as a second line of defense to prevent flow of intake gas, after the valve 125a and/or the valve 125b. In some embodiments, the valve 125c can be used to block the flow of gas instead of valve 125a, as both valve 125a and valve 125c affect the resistance to flow through the CAC 120. In some embodiments, the valve 125c can be used as a throttle valve. In some embodiments, the heater 135 can heat gas as it moves between the second flow path 130 and the third flow path 140. In some embodiments, the heater 135 can include a grid heater, a block heater, an intake heater-cartridge system, an external cartridge heater, an intake-heater, a fuel-powered burner, reactor, or other device, a heat exchanger with a hot fluid, or any combination thereof. In some embodiments, the heater 135 can be disposed outside of the second flow path 130 and/or the third flow path 140. In some embodiments, the heater 135 can be disposed inside the second flow path 130 and/or the third flow path 140. In some embodiments, the heater 135, burner, heat exchanger, or other device can be in physical contact with the intake manifold 150.

The third flow path 140 can guide the intake fluid to the intake manifold 150. The third flow path 140 can be fluidically coupled to the second flow path 130. In some embodiments, the third flow path 140 can be fluidically coupled to the CAC 120 or blocked from the CAC via the valve 125c. In some embodiments, the third flow path 140 can have similar dimensions or diameter to the first flow path 110 and/or the second flow path 130.

The intake manifold 150 partitions the volume of intake gas into sections, which feed to the combustion chambers 160. In some embodiments, the heater 135 can heat gas as it moves between the intake manifold 150 and the combustion chambers 160. In some embodiments, the heater 135 can include a grid heater, a block heater, an intake heater-cartridge system, an external cartridge heater, an intake-heater, a fuel-powered burner, reactor, or other device, a heat exchanger with a hot fluid, or any combination thereof. In some embodiments the heaters can be controlled in response to measurements of intake temperature exhaust temperature, or other values measured on the engine to achieve a target IVC temperature. Combustion of fuel occurs inside the combustion chambers 160. In some embodiments, the combustion chambers 160 can include a collection of cylinders. In some embodiments, the combustion can occur via compression ignition. In some embodiments, the combustion chambers 160 can include an inner surface, a head surface, a piston disposed and configured to move in the engine cylinder, an intake valve, and an exhaust valve (not shown). In some embodiments, the engine 100 can include about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, or about 32 cylinders. In some embodiments, the ports into one or more of the combustion chambers 160 can include temperature sensors disposed therein. In some embodiments, one or more of the combustion chambers 160 can include temperature sensors disposed therein.

The EGR path 170 is optional and diverts a portion of the exhaust from the combustion chambers 160 back through the intake manifold 150 and back into the combustion chambers 160. The EGR path 170 aids in achieving a target intake manifold temperature and target IVC temperature. The EGR path 170 can include a tube and optional adjustable flow restriction (valve or other) to control the level of exhaust recirculated into the intake. In some embodiments the EGR path 170 can include a series of tubes that recirculate the exhaust. In some embodiments, the EGR path 170 can divert at least about 2%, at least about 4%, at least about 6%, at least about 8%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or nearly all of the exhaust from the combustion chambers 160.

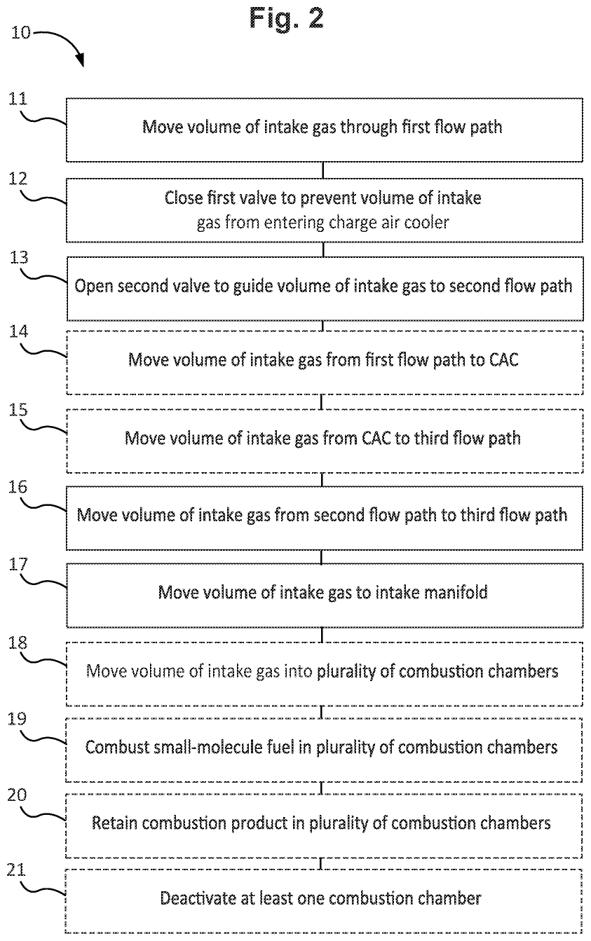

FIG. 2 is a block diagram of a method 10 of operating an engine with an intake temperature management system, according to an embodiment. As shown, the method 10 includes moving the volume of intake gas through a first flow path at step 11, closing a first valve to restrict the flow of the volume of intake gas through a CAC at step 12, and opening a second valve to increase the fraction of the volume of intake gas flowing to a second flow path at step 13. The method 10 optionally includes moving the volume of intake gas from the first flow path to the CAC at step 14 and moving the volume of intake gas from the CAC to a third flow path at 15. The method 10 further includes moving the volume of intake gas from the second flow path to the third flow path at step 16 and moving the volume of the intake gas to the intake manifold at step 17. The method 10 optionally includes moving the volume of intake gas into a plurality of combustion chambers at step 18, combusting a small-molecule fuel in the plurality of combustion chambers at step 19, retaining a combustion product in the plurality of combustion chambers at step 20, and deactivating at least one of the combustion chambers at step 21.

Step 11 includes moving the volume of intake gas through the first flow path. The intake gas participates in the combustion reaction and allows combustion of a fuel. In some embodiments, the intake gas can include air. In some embodiments, the intake gas can include ambient air. In some embodiments, the intake gas can include oxygen and nitrogen. In some embodiments, the intake gas can include a combination of oxygen and an inert gas. In some embodiments, the intake gas can include at least about 5 vol %, at least about 10 vol %, at least about 15 vol %, at least about 20 vol %, at least about 25 vol %, at least about 30 vol %, at least about 35 vol %, at least about 40 vol %, or at least about 45 vol % oxygen, inclusive of all values and ranges therebetween. In some embodiments, the intake gas can include no more than about 50 vol %, no more than about 45 vol %, no more than about 40 vol %, no more than about 35 vol %, no more than about 30 vol %, no more than about 25 vol %, no more than about 20 vol %, no more than about 15 vol %, or no more than about 10 vol % oxygen. Combinations of the above-referenced percentages of oxygen are also possible (e.g., at least about 5 vol % and no more than about 50 vol % or at least about 10 vol % and no more than about 30 vol %), inclusive of all values and ranges therebetween. In some embodiments, the intake gas can include about 5 vol %, about 10 vol %, about 15 vol %, about 20 vol %, about 25 vol %, about 30 vol %, about 35 vol %, about 40 vol %, about 45 vol %, or about 50 vol %.

In some embodiments, the volume of intake gas can be fed to the first flow path at a pressure of at least about 0.01 bar (gauge), at least about 0.02 bar, at least about 0.03 bar, at least about 0.04 bar, at least about 0.05 bar, at least about 0.06 bar, at least about 0.07 bar, at least about 0.08 bar, at least about 0.09 bar, at least about 0.1 bar, at least about 0.2 bar, at least about 0.3 bar, at least about 0.4 bar, at least about 0.5 bar, at least about 0.6 bar, at least about 0.7 bar, at least about 0.8 bar, at least about 0.9 bar, at least about 1 bar, at least about 2 bar, at least about 3 bar, at least about 4 bar, at least about 5 bar, at least about 6 bar, at least about 7 bar, at least about 8 bar, at least about 9 bar, at least about 100 bar, at least about 110 bar, at least about 120 bar, at least about 130 bar, at least about 140 bar, at least about 150 bar, at least about 160 bar, at least about 170 bar, at least about 180 bar, or at least about 190 bar. In some embodiments, the volume of intake gas can be fed at a pressure of no more than about 200 bar, no more than about 190 bar, no more than about 180 bar, no more than about 170 bar, no more than about 160 bar, no more than about 150 bar, no more than about 140 bar, no more than about 130 bar, no more than about 120 bar, no more than about 110 bar, no more than about 100 bar, no more than about 90 bar, no more than about 80 bar, no more than about 70 bar, no more than about 60 bar, no more than about 50 bar, no more than about 40 bar, no more than about 30 bar, no more than about 20 bar, no more than about 10 bar, no more than about 9 bar, no more than about 8 bar, no more than about 7 bar, no more than about 6 bar, no more than about 5 bar, no more than about 4 bar, no more than about 3 bar, no more than about 2 bar, no more than about 1 bar, no more than about 0.9 bar, no more than about 0.8 bar, no more than about 0.7 bar, no more than about 0.6 bar, no more than about 0.5 bar, no more than about 0.4 bar, no more than about 0.3 bar, no more than about 0.2 bar, no more than about 0.1 bar, no more than about 0.09 bar, no more than about 0.08 bar, no more than about 0.07 bar, no more than about 0.06 bar, no more than about 0.05 bar, no more than about 0.04 bar, no more than about 0.03 bar, or no more than about 0.02 bar. Combinations of the above-referenced pressures are also possible (e.g., at least about 0.01 bar and no more than about 200 bar or at least about 2 bar and no more than about 100 bar, inclusive of all values and ranges therebetween. In some embodiments, the first flow path at a pressure of about 0.01 bar, about 0.02 bar, about 0.03 bar, about 0.04 bar, about 0.05 bar, about 0.06 bar, about 0.07 bar, about 0.08 bar, about 0.09 bar, about 0.1 bar, about 0.2 bar, about 0.3 bar, about 0.4 bar, about 0.5 bar, about 0.6 bar, about 0.7 bar, about 0.8 bar, about 0.9 bar, about 1 bar, about 2 bar, about 3 bar, about 4 bar, about 5 bar, about 6 bar, about 7 bar, about 8 bar, about 9 bar, about 10 bar, about 20 bar, about 30 bar, about 40 bar, about 50 bar, about 60 bar, about 70 bar, about 80 bar, about 90 bar, about 100 bar, about 110 bar, about 120 bar, about 130 bar, about 140 bar, about 150 bar, about 160 bar, about 170 bar, about 180 bar, about 190 bar, or about 200 bar.

Step 12 includes closing a first valve to prevent the volume of intake gas from entering the CAC. In some embodiments, the closing of a first valve can be a full closing. In some embodiments, the closing of the first valve can be a partial closing. Step 13 includes opening the second valve to guide allow volume of intake gas to pass through the second flow path. In some embodiments, the second flow path can completely bypass the CAC. In some embodiments, the diversion from the CAC can be a full diversion. In some embodiments, the diversion from the CAC can be a partial diversion.

In some embodiments, at least about 10 vol %, at least about 15 vol %, at least about 20 vol %, at least about 25 vol %, at least about 30 vol %, at least about 35 vol %, at least about 40 vol %, at least about 45 vol %, at least about 50 vol %, at least about 55 vol %, at least about 60 vol %, at least about 65 vol %, at least about 70 vol %, at least about 75 vol %, at least about 80 vol %, at least about 85 vol %, at least about 90 vol %, or at least about 95 vol % of the volume of intake gas can be diverted to the second flow path. In some embodiments, no more than about 100 vol %, no more than about 95 vol %, no more than about 90 vol %, no more than about 85 vol %, no more than about 80 vol %, no more than about 75 vol %, no more than about 70 vol %, no more than about 65 vol %, no more than about 60 vol %, no more than about 55 vol %, no more than about 50 vol %, no more than about 45 vol %, no more than about 40 vol %, no more than about 35 vol %, no more than about 30 vol %, no more than about 25 vol %, no more than about 20 vol %, or no more than about 15 vol % of the volume of the intake gas can be diverted to the second flow path. Combinations of the above-referenced diversion percentages are also possible (e.g., at least about 10 vol % and no more than about 100 vol % or at least about 20 vol % and no more than about 70 vol %), inclusive of all values and ranges therebetween. In some embodiments, about 10 vol %, about 15 vol %, about 20 vol %, about 25 vol %, about 30 vol %, about 35 vol %, about 40 vol %, about 45 vol %, about 50 vol %, about 55 vol %, about 60 vol %, about 65 vol %, about 70 vol %, about 75 vol %, about 80 vol %, about 85 vol %, about 90 vol %, about 95 vol %, or about 100 vol % of the volume of intake gas can be diverted to the second flow path.

In some embodiments, the percentage of intake gas diverted can be based on a measured parameter. In some embodiments, the measured parameter can include a temperature at a point in the engine. In some embodiments, the measured parameter can include a temperature inside one or more of the intake ports. In some embodiments, the measured parameter can include a temperature in the intake manifold. In some embodiments, the measured parameter can include a temperature in one or more of the combustion chambers. In some embodiments, the measured parameter can include relative permittivity of the fuel, pH of the fuel, boiling point of the fuel, vaporization point of the fuel, infrared spectroscopy of the fuel, pressure in the engine, oxygen content in the combustion chambers, or any combination thereof. As an example, if a temperature detected inside a combustion chamber is lower than a desired value, the proportion of intake gas being diverted away from the CAC can be increased. In some embodiments, the diversion of the intake gas can be executed automatically (e.g., based on an algorithm).

Depending on position of first and second valves, Step 14 is optional and includes moving the volume of intake gas from the first flow path to the CAC. Step 15 is optional and includes moving the volume of intake gas from the CAC to the third flow path. The portion of intake gas not used in bypassing the CAC can be fed to the CAC and to the third flow path.

Depending on position of first and second valves, Step 16 is optional and includes moving the volume of the intake gas from the second flow path to the third flow path. In some embodiments, the portion of the intake gas that was fed to the CAC at step 14 can mix with the volume of intake gas fed to the third flow path at step 16. In some embodiments, the first flow path, the second flow path, and/or the third flow path can include a heater or other device to increase temperature of the air passing through it. Step 17 includes moving the volume of the intake gas to the intake manifold. Step 17 can include dividing the intake gas into multiple streams. In some embodiments, the streams can be evenly distributed or approximately evenly distributed.

Step 18 is optional and includes moving the volume of the intake gas to the plurality of combustion chambers. In some embodiments, the movement of the intake gas can be via the intake manifold. In some embodiments, upon activating a temperature management strategy, the average temperature in the intake manifold or at IVC inside the plurality of combustion chambers can increase by at least about 5° C., at least about 10° C., at least about 15° C., at least about 20° C., at least about 25° C., at least about 30° C., at least about 35° C., at least about 40° C., at least about 45° C., at least about 50° C., at least about 75° C., at least about 100° C., at least about 125° C., at least about 150° C., at least about 175° C., at least about 200° C., at least about 300° C., at least about 400° C., or at least about 500° C. In some embodiments, upon activating a temperature management strategy, the average temperature in the intake manifold or at IVC inside the plurality of combustion chambers can increase by no more than about 600° C. no more than about 500° C., no more than about 400° C., no more than about 300° C., no more than about 200° C., no more than about 175° C., no more than about 150° C., no more than about 125° C., no more than about 100° C., no more than about 75° C., no more than about 50° C., no more than about 45° C., no more than about 40° C., no more than about 35° C., no more than about 30° C., no more than about 25° C., no more than about 20° C., no more than about 15° C., or no more than about 10° C. Combinations of the above-referenced temperature increases are also possible (e.g., at least about 5° C. and no more than about 600° C. or at least about 25° C. and no more than about 150° C.), inclusive of all values and ranges therebetween. In some embodiments, upon activating a temperature management strategy, the average temperature in the intake manifold or at IVC inside the plurality of combustion chambers can increase by about 5° C., about 10° C., about 15° C., about 20° C., about 25° C., about 30° C., about 35° C., about 40° C., about 45° C., about 50° C., about 75° C., about 100° C., about 125° C., about 150° C., about 175° C., about 200° C., about 300° C., about 400° C., about 500° C., or about 600° C.

Step 19 is optional and includes combusting a small-molecule fuel in the plurality of combustion chambers. In some embodiments, the fuel can include a low-cetane fuel. In some embodiments, the fuel can have a cetane number of at least about −10, at least about −5, at least about 0, at least about 5, at least about 10, at least about 15, at least about 20, at least about 25, at least about 30, or at least about 35. In some embodiments, the fuel can have a cetane number of no more than about 40, no more than about 35, no more than about 30, no more than about 25, no more than about 20, no more than about 15, no more than about 10, no more than about 5, no more than about 0, or no more than about −5. Combinations of the above-referenced cetane numbers of the fuel are also possible (e.g., at least about −10 and no more than about 40 or at least about 10 and no more than about 20), inclusive of all values and ranges therebetween. In some embodiments, the fuel can have a cetane number of about −10, about −5, about 0, about 5, about 10, about 15, about 20, about 25, about 30, about 35, or about 40.

In some embodiments, the fuel can include naphtha, gasoline, alcohol, butanol, propanol, ethanol, methanol, a gasoline/ethanol mixture, a gasoline/methanol mixture, methanol/ethanol mixture, a denatured alcohol, hydrous alcohol, gaseous hydrocarbons, natural gas, methane, ethane, propane, butane, hexane, alternative fuels, hydrogen, ammonia, syngas, and/or CO. In some embodiments, the fuel can have a low amount of additives that result in a substantial change in cetane number. In some embodiments, the fuel can include less than about 5,000 ppm, less than about 4,000 ppm, less than about 3,000 ppm, less than about 2,000 ppm, less than about 1,000 ppm, less than about 900 ppm, less than about 800 ppm, less than about 700 ppm, less than about 600 ppm, or less than about 500 ppm by weight of additives that result in a substantial change in cetane number. In some embodiments, the fuel can be substantially free of additives that result in a substantial change in cetane number.

In some embodiments, the fuel can have an octane number (i.e., calculated via (RON+MON)/2 method) of at least about 50, at least about 55, at least about 60, at least about 65, at least about 70, at least about 75, at least about 80, at least about 85, at least about 90, at least about 95, at least about 100, at least about 105, at least about 110, at least about 115, at least about 120, at least about 125, at least about 130, at least about 135, at least about 140, or at least about 145. In some embodiments, the fuel can have an octane number of no more than about 150, no more than about 145, no more than about 140, no more than about 135, no more than about 130, no more than about 125, no more than about 120, no more than about 115, no more than about 110, no more than about 105, no more than about 100, no more than about 95, no more than about 90, no more than about 85, no more than about 80, no more than about 75, no more than about 70, no more than about 65, no more than about 60, or no more than about 55. Combinations of the above-referenced octane numbers are also possible (e.g., at least about 50 and no more than about 150 or at least about 80 and no more than about 120, inclusive of all values and ranges therebetween. In some embodiments, the fuel can have an octane number of about 50, about 55, about 60, about 65, about 70, about 75, about 80, about 85, about 90, about 95, about 100, about 105, about 110, about 115, about 120, about 125, about 130, about 135, about 140, about 145, or about 150.

In some embodiments, the fuel can include a fuel with 1 carbon atom per molecule (e.g., methane, methanol). In some embodiments, the fuel can be free of carbon atoms (e.g., hydrogen or ammonia). In some embodiments, the fuel can include a fuel with at least about 1 carbon atom per molecule, at least about 2 carbon atoms per molecule, at least about 3 carbon atoms per molecule, at least about 4 carbon atoms per molecule, at least about 5 carbon atoms per molecule, at least about 6 carbon atoms per molecule, at least about 7 carbon atoms per molecule, at least about 8 carbon atoms per molecule, or at least about 9 carbon atoms per molecule. In some embodiments, the fuel can include a fuel with no more than about 10 carbon atoms per molecule, no more than about 9 carbon atoms per molecule, no more than about 8 carbon atoms per molecule, no more than about 7 carbon atoms per molecule, no more than about 6 carbon atoms per molecule, no more than about 5 carbon atoms per molecule, no more than about 4 carbon atoms per molecule, no more than about 3 carbon atoms per molecule, or no more than about 2 carbon atoms per molecule. Combinations of the above-referenced numbers of carbon atoms per molecule are also possible (e.g., at least about 1 carbon atom per molecule and no more than about 10 carbon atoms per molecule or at least about 1 carbon atom per molecule and no more than about 3 carbon atoms per molecule), inclusive of all values and ranges therebetween. In some embodiments, the fuel can include a fuel with about 1 carbon atom per molecule, about 2 carbon atoms per molecule, about 3 carbon atoms per molecule, about 4 carbon atoms per molecule, about 5 carbon atoms per molecule, about 6 carbon atoms per molecule, about 7 carbon atoms per molecule, about 8 carbon atoms per molecule, about 9 carbon atoms per molecule, or about 10 carbon atoms per molecule.

In some embodiments, the fuel can be mixed with the volume of volume of intake gas in a lean mixture ratio, a rich mixture ratio, or a stoichiometric mixture ratio. In some embodiments, the volume of intake gas and the fuel can have an excess air ratio (λ) of at least about 0.1, at least about 0.2, at least about 0.3, at least about 0.4, at least about 0.5, at least about 0.6, at least about 0.7, at least about 0.8, at least about 0.9, at least about 1, at least about 1.1, at least about 1.2, at least about 1.3, at least about 1.4, at least about 1.5, at least about 1.6, at least about 1.7, at least about 1.8, at least about 1.9, at least about 2, at least about 3, at least about 4, at least about 5, at least about 6, at least about 7, at least about 8, or at least about 9. In some embodiments, k can be no more than about 10, no more than about 9, no more than about 8, no more than about 7, no more than about 6, no more than about 5, no more than about 4, no more than about 3, no more than about 2, no more than about 1.9, no more than about 1.8, no more than about 1.7, v no more than about 1.6, no more than about 1.5, no more than about 1.4, no more than about 1.3, no more than about 1.2, no more than about 1.1, no more than about 1, no more than about 0.9, no more than about 0.8, no more than about 0.7, no more than about 0.6, no more than about 0.5, no more than about 0.4, no more than about 0.3, or no more than about 0.2. Combinations of the above-referenced k values are also possible (e.g., at least about 0.1 and no more than about 10 or at least about 0.5 and no more than about 5), inclusive of all values and ranges therebetween. In some embodiments, k can be about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 3, about 4, about 5, about 6, about 7, about 8, about 9, or about 10.

Step 20 is optional and includes retaining a combustion product or portion of a combustion product in the plurality of combustion chambers. In some embodiments, the retention of the combustion product of the plurality of combustion chambers can include trapping or restricting outflow via closing or partially closing exhaust valve. In some embodiments, the retention of the combustion product can be done instead of recirculated exhaust (EGR). In some embodiments, the retention of the combustion product can be in addition to recirculated exhaust EGR.

Step 21 is optional and includes deactivating at least one cylinder. In some embodiments, the deactivation of the cylinder can include closing the intake valve and the exhaust valve and deactivating the fuel injector. Further descriptions of cylinder deactivation are described in U.S. Patent Publication No. 2022/0018297 (“the '297 publication”), filed Sep. 30, 2021 and titled “Systems and Methods of Cylinder Deactivation in High-Temperature Mixing-Controlled Engines,” the disclosure of which is hereby incorporated by reference in its entirety.

FIGS. 3A-3B are illustrations of an engine 200 with an intake temperature management system, according to an embodiment. As shown, the engine 200 includes a first flow path 210, a CAC 220, valves 225a, 225b (collectively referred to as valves 225), a second flow path 230, a heater 235, a third flow path 240, an intake manifold 250, a plurality of combustion chambers 260, and an EGR path 270 with an EGR valve 275. In some embodiments, the first flow path 210, the CAC 220, the valves 225, the second flow path 230, the heater 235, the third flow path 240, the intake manifold 250, the combustion chambers 260, and the EGR bypass 270 can be the same or substantially similar to the first flow path 110, the CAC 120, the valves 125, the second flow path 130, the heater 135, the third flow path 140, the intake manifold 150, the combustion chambers 160, and the EGR path 170, as described above with reference to FIG. 1. Thus, certain aspects of the first flow path 210, the CAC 220, the valves 225, the second flow path 230, the heater 235, the third flow path 240, the intake manifold 250, the combustion chambers 260, and the EGR path 270 are not described in greater detail herein. As shown in FIG. 3A, the intake gas bypasses the CAC 220 via the open/closed state of the valves 225. As shown in FIG. 3B, the intake gas moves through the CAC 220 via the open/closed state of the valves 225.

As shown, two connection areas exist between the first flow path 210 and the third flow path 240. One connection area includes the CAC 220 and the other connection area includes the second flow path 230, which bypasses the CAC 220. In some embodiments, theses connection points can be optimized aerodynamically. In some embodiments, the valve 225a can be excluded, depending on noise and flow control considerations. In some embodiments, the valve 225b can be used as a throttle valve. In some embodiments, the valves 225 can be operated such that the bypass valve 225b only opens under engine idle or startup conditions but has a default state of being closed. In some embodiments, the valves 225 can be partially opened to effect throttling. In some embodiments, the valve 225a can have a default open state, such that it only closes under engine idle or startup conditions. In some embodiments, the valve 225a can be installed downstream of the CAC 220.

As shown, the EGR path 270 leads back to the intake manifold 250. The EGR valve 275 regulates the flow of exhaust gas. In some embodiments, the EGR path 270 can include tubing. In some embodiments, the EGR bypass 270 can have a smaller diameter than the first flow path 210, the second flow path 230, and/or the third flow path. In some embodiments, the EGR bypass 270 can have a diameter the same or substantially similar to the first flow path 210, the second flow path 230, and/or the third flow path.

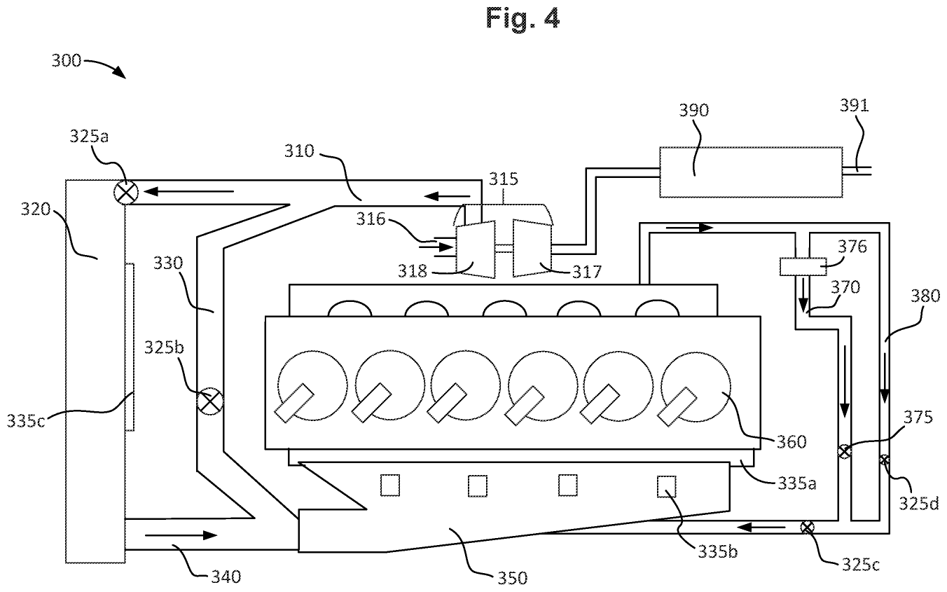

FIG. 4 is an illustration of an engine 300 with an intake temperature management system, according to an embodiment. As shown, the engine 300 includes a first flow path 310, a turbocharger 315, a CAC 320, valves 325a, 325b, 325c, 325d (collectively referred to as valves 325), a second flow path 330, heaters 335a, 335b, 335c (collectively referred to as heaters 335), a third flow path 340, an intake manifold 350, a plurality of combustion chambers 360, an EGR path 370, an uncooled EGR path 380, and an aftertreatment 390. In some embodiments, the valve 325a can be installed downstream of the CAC 320. In some embodiments, the valves 325 can be partially opened to effect throttling. In some embodiments, the first flow path 310, the CAC 320, the valves 325, the second flow path 330, the heaters 335, the third flow path 340, the intake manifold 350, the plurality of combustion chambers 360, and the EGR path 370 can be the same or substantially similar to the first flow path 110, the CAC 120, the valves 125, the second flow path 130, the heaters 135, the third flow path 140, the intake manifold 150, the plurality of combustion chambers 160, and the EGR path 170, as described above with reference to FIG. 1. Thus, certain aspects of the first flow path 310, the CAC 320, the valves 325, the second flow path 330, the heaters 335, the third flow path 340, the intake manifold 350, the plurality of combustion chambers 360, and the EGR path 370. In some embodiments, the engine 300 can be guided via a proprietary controller.

As shown, the turbocharger 315 includes an intake gas inlet 316, a turbine 317, and compressor 318. In some embodiments, exhaust gas can flow into the inlet 316 to power the turbine 317. In some embodiments, the exhaust gas can flow from the turbocharger 315 to the aftertreatment 390 and out of the aftertreatment 390 via an outlet 391. The intake gas flows through the first flow path 310 after being pressurized in the turbocharger 315.

The heaters 335 can be located at various points throughout the engine 300. The heater 335a can include an intake grid heater that heats the intake manifold 350 and the combustion chambers 360. In some embodiments, the heater 335b can include a power relay grid heater that heats the intake manifold 350. In some embodiments, the heater 335c can include a power relay grid heater attached to the CAC 320. Packaging space for heating elements is a significant challenge with the use of such heaters. This includes space for the heater itself as well as a means of delivering power to the heater, while placing the heat source close enough to the intake ports of the engine 300, such that heat transfer to the walls of the flow paths and the intake manifold 350 is reduced after heating the intake gas.

One heating example calculation for a small-molecule low cetane fuel engine includes increasing the air temperature from cold ambient conditions to a sufficient temperature at the closing of the intake valve (i.e., IVC temperature) to maintain engine idle just after the engine 300 starts and before the engine 300 has reached operating temperature. In an ethanol example case on a −25° C. day, air as the intake gas can be heated to 150° C. at 900 rpm on a 15L engine. The power requirement for such a heating operation is 15 kW. Considering that only approximately 60% of the added heat might reach the cylinder (due to heat loss), a more realistic power requirement of 25 kW may be needed. For perspective, this is approximately 85,000 BTU/hr, roughly equivalent to the heat output of a typical residential furnace or approximately 16 portable electric heaters (1,500 Watts each). Current draw on a 12V battery would be approximately 2,000 amps, which is much more than a typical engine starter motor. The intake manifold 350 can incur low flow recirculation, creating a uniform flow pattern in the heaters 335. Such a uniform flow pattern can aid in creating a modular design feature for the heaters 335, whose performance is independent of the upstream flow pattern. The intake manifold 350 can allow enhanced flow swirl or deflection to facilitate temperature mixing, alleviating the need of additional temperature mixing units downstream.

FIGS. 3A-3B and FIG. 4 show example layouts for intake heating that are particularly suited to the packaging constraints of electric heaters. By locating the electrical heaters as close to the cylinder head and intake ports (not shown) of the combustion chambers 360 as possible, more of the heat reaches the combustion chambers 360. In addition, the air space just in front of the combustion chambers 360 can be preheated, so that the first air the engine draws in upon cranking is at a temperature sufficient for combustion.

In some embodiments, one or more of the heaters 335 can include high-power electric heaters, closely coupled to the intake ports to reduce heat transfer opportunities and quickly start the engine 300. However, extended operation of electric heaters may be undesirable or may be beyond practical battery reserve capacity and engine-mounted alternator current capacity. In some embodiments, the heaters 335 can be coupled with a control system for optimizing pre-heat time and current. The control system also modulates current after engine cranks and runs to meet engine combustion requirements while keeping heating element temperature below the maximum for adequate element life. In some embodiments, the electric voltage can be about 12 V, about 24 V, or about 48 V DC, or any voltage available on the vehicle or at the engine installation site, including 120-480V AC. In some embodiments, any of the heaters 335 can be placed upstream of the intake manifold 350, as shown in FIG. 4, in conjunction with engine architecture changes as shown in FIG. 4, to raise charge temperature at intake manifold.

The EGR path 370 allows the flow of exhaust gas from the combustion chambers 360 back to the intake manifold 350 and flow through the EGR path can be adjusted via an EGR valve 375. As shown, the EGR path 370 includes an EGR cooler 376. The EGR cooler 376 can aid in cooling the gas circulated through the EGR path 370. In some embodiments, the EGR cooler 376 can include a welded-tube heat exchanger, a heavy duty welded-tube heat exchanger, a bar-plate heat exchanger, a liquid cooled heat exchanger, a bar-plate liquid cooled heat exchanger, a round-tube plate fin liquid cooled heat exchanger, or any combination thereof.

The uncooled EGR path 380 allows for the flow of intake gas from the combustion chambers 360 back to the intake manifold 350 without passing through a cooler. The valve 325d regulates the flow of gas through the uncooled EGR path 380. The aftertreatment 390 can remove harmful emissions from the exhaust. In some embodiments, the aftertreatment 390 can include a catalytic converter. In some embodiments, the aftertreatment 390 can include one or more sensors.

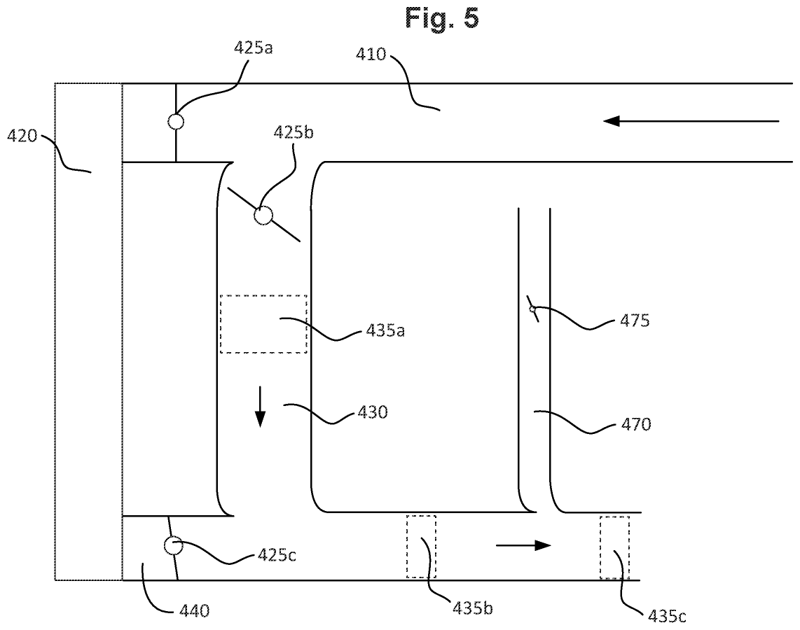

FIG. 5 is an illustration of a series of flow paths of an engine with an intake temperature management system, according to an embodiment. As shown, the engine includes a first flow path 410, a CAC 420, valves 425a, 425b, 425c (collectively referred to as valves 425), a second flow path 430, heaters 435a, 435b, 435c (collectively referred to as heaters 435), a third flow path 440, an EGR bypass 470, and an EGR bypass valve 475. In some embodiments, the first flow path 410, the CAC 420, the valves 425, the second flow path 430, the heaters 435, the third flow path 440, the EGR path 470, and the EGR valve 475 can be the same or substantially similar to the first flow path 310, the CAC 320, the valves 325, the second flow path 330, the heaters 335, the third flow path 340, the EGR path 370, and the EGR valve 375, as described above with reference to FIGS. 3A-3B. Thus, certain aspects of the first flow path 410, the CAC 420, the valves 425, the second flow path 430, the heaters 435, the third flow path 440, the EGR path 470, and the EGR valve 475 are not described in greater detail herein. In some embodiments, the valves 425 can be partially opened to effect throttling.

FIG. 5 shows various locations of the heaters 435. As shown, the heater 435a is located along the second flow path 430, the heater 435b is located along the third flow path 440 upstream of the EGR path 470, and the heater 435c is located along the third flow path 440 downstream of the EGR path 470. Each of the heaters 435 is optional. In other words, the engine can include the heater 435a, the heater 435b, the heater 435c, or any combination thereof. As shown, the valves 425 are oriented such that the flow of the intake gas bypasses the CAC 420. In some embodiments, the intake gas in its entirety or a portion thereof can flow through the CAC 420.

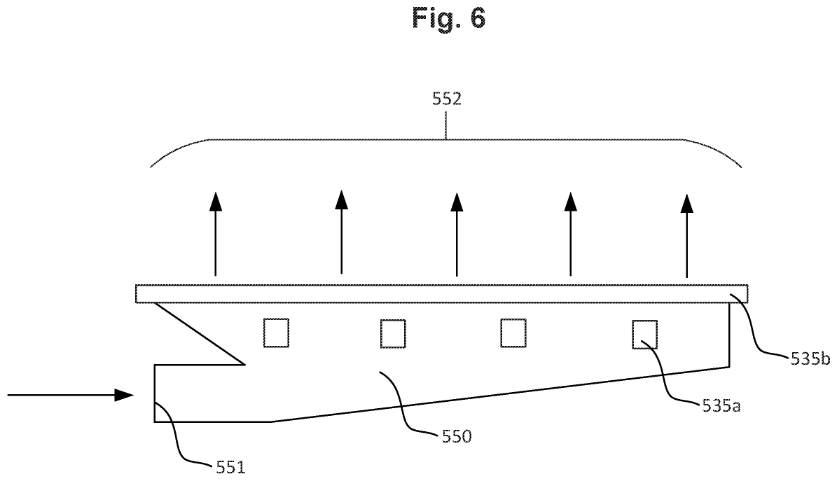

FIG. 6 shows an intake manifold 550 with heaters 535a, 535b (collectively referred to as heaters 535) incorporated therein. In some embodiments, the intake manifold 550 and the heaters 535 can be the same or substantially similar to the intake manifold 350 and the heaters 335, as described above with reference to FIG. 4. Thus, certain aspects of the intake manifold 550 and the heaters 535 are not described in greater detail herein. As shown, multiple heaters 335 are incorporated into the intake manifold. In some embodiments, one or more of the heaters 335 can be disposed inside the intake manifold 550. In some embodiments, one or more of the heaters 335 can be disposed outside the intake manifold 550. The volume of intake gas flows into the intake manifold 550 via an inlet 551 and exits the intake manifold 550 via a plurality of outlets 552.

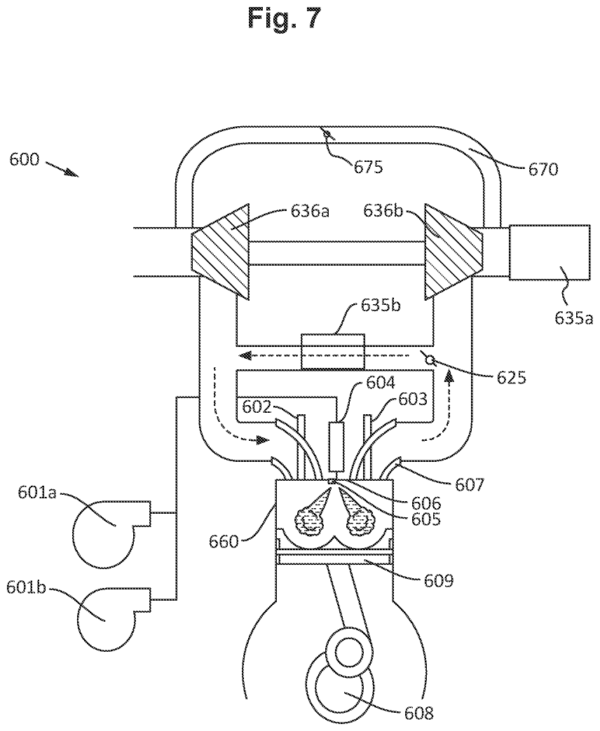

FIG. 7 shows an engine 600 with an alternate configuration for uncooled or partially cooled EGR, where exhaust gas is extracted after a turbine and brought back in before a compressor. As shown, the engine 600 includes fuel sources 601a, 601b (collectively referred to as fuel sources 601), an intake valve 602, an exhaust valve 603, a fuel injector 604, a sensor 605, an engine head 606, a thermal barrier coating 607, a crankshaft 608, a piston 609, high-pressure EGR valve 625, heaters 635a, 635b (collectively referred to as heaters 635), compressors 636a, 636b (collectively referred to as compressors 636) a combustion chamber 660, an EGR path 670 with a low-pressure EGR valve 675. In some embodiments, the high-pressure EGR valve 625, the heaters 635, the combustion chamber 660, the EGR bypass 670, and the low-pressure EGR valve 675 can be the same or substantially similar to the valves 325, the heaters 335, the combustion chambers 360, the EGR path 370, and the EGR valve 375, as described above with reference to FIG. 4. Thus, certain aspects of the high-pressure EGR valve 625, the heaters 635, the combustion chamber 660, the EGR path 670, and the low-pressure EGR valve 675 are not described in greater detail herein.

In some embodiments, the fuel source 601a can include the same fuel as the fuel source 601b. In some embodiments, the fuel source 601b can include a different fuel from the fuel source 601b. The volume of intake gas passes through the intake valve 602 to enter the combustion chamber. A volume of fuel is injected into the combustion chamber 660 via the fuel injector 604. The crankshaft 608 causes the piston 609 to move and compress the volume of fuel and the volume of intake gas, such that the volume of fuel combusts in the combustion chamber 660. Upon combustion, the exhaust exits via the exhaust valve 603. After combustion, the exhaust can move through the EGR bypass 670. The high-pressure EGR valve 625 is a recirculation port that recirculates gas back to the combustion chamber 660. The EGR bypass 670 diverts a portion of the exhaust back to the combustion chamber 660. The high-pressure EGR valve 625 is on a high pressure side of the compressors 636 while the low-pressure EGR valve 675 is on a low pressure side of the compressors 636.

To accommodate scenario (D) of high load operation noted above, high engine speeds and hot ambient temperatures, cooling devices, rather than heating, can be used. For this reason, the CAC (not shown) can be retained to be used when recirculated exhaust temperatures are high, and for high power density applications, adjustable or partial EGR cooling can be used to avoid intake temperatures significantly higher than those needed to achieve autoignition of small-molecule or low-cetane fuels.

In some embodiments, an engine can employ the strategies described herein in parallel. While independent use of each of these methods is possible, their combination is within the scope of this disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “fuel” can refer to any material capable of producing an exothermic chemical reaction with an intake mixture, regardless of the fuel's cetane number. This can include fuels and blends of: naphtha, gasoline, alcohol fuels (including butanol, propanol, ethanol, and methanol), gaseous hydrocarbons (including natural gas, methane, ethane, propane, butane, hexane, etc.) and alternative fuels such as hydrogen, ammonia, syngas, CO, etc.

As used herein, “plume” can refer to a mass of fuel spreading from an injection point, which may be entraining or mixing with the volume of intake charge as it progresses spatially and/or temporally during a fuel injection event.

As used herein, “intake charge” refers to a volume of material that enters a combustion chamber prior to a combustion event. The intake charge can include air, atmospheric air, humid air, air enriched with oxygen, air diluted with exhaust gas, air diluted with inert gas, fuel, uncombusted fuel, or any combination thereof.

As used herein, “small-molecule fuels” refers to fuels having less than or equal to four carbon atoms per molecule on average (including zero carbon atoms per molecule). This can include hydrogen, ammonia, carbon monoxide (CO), syngas, natural gas, methane, methanol, ethane, ethene, ethanol, di-methyl-ether, propane, propanol, butane, butanol, iso-butanol, and other fuels and fuel blends meeting the criteria of less than or equal to four carbon atoms per molecule on average.

As used herein, “combustion efficiency” can refer to the degree to which air and fuel are fully combusted to form the products of complete combustion. As a non-limiting example, combustion efficiency can be calculated using lower heating value (LHV) of the fuel (e.g., ethanol, methanol, etc.) and combustion products (e.g., CO₂, H₂O, etc.), as set forth below:

$${η}_{combustion} = 1 - \frac{{LHV}_{products} {mass}_{products}}{{LHV}_{fuel} {mass}_{fuel}}$$

### Where:

η_{combustion} is the combustion efficiency;
LHV_{products} is the LHV of the combustion products (MJ/kg);
mass_{products} is the mass of the combustion products (kg);
LHV_{fuel} is the LHV of the fuel (MJ/kg); and
mass_{fuel} is the mass of the fuel (kg).

As used herein, “efficiency,” “thermal efficiency,” or “LHV efficiency” can refer to the conversion of fuel energy to mechanical work, calculated as follows:

$$η = \frac{Work}{{LHV}_{fuel} {mass}_{fuel}}$$

### Where:

η is the efficiency;
Work is the amount of mechanical work achieved (J), which can be the indicated work calculated from the pressure in the engine cylinder, or the brake work, where the work is measured at the point of the rotating shaft going from the engine into a transmission or generator (i.e., the “brake thermal efficiency);
LHV_{fuel} is the LHV of the fuel (J/kg); and
mass_{fuel} is the mass of the fuel (kg).

As used herein, a numerical definition of a “crank angle” or an “engine crank angle” should be understood as the crank angle relative to a fixed point in the engine cycle (as described below in Table 1 for the case of a four-stroke engine). In other words, in a four-stroke engine, the engine crank angle is 0° (or 720°) when the piston is in the TDC position between the exhaust stroke and the intake stroke. The engine crank angle is 3600 when the piston is in the TDC position between the compression stroke and the expansion stroke. The engine crank angle is 5400 when the piston is in the BDC position between the expansion stroke and the exhaust stroke. The engine crank angle is 1800 when the piston is in the BDC position between the intake stroke and the compression stroke. Negative numbers can also be used to describe the crank angle relative to the TDC position between the exhaust stroke and the intake stroke. In other words, 540° can also be described as −180°, 360° can also be described as −360°, and 180° can also be described as −540°.

TABLE 1
Crank Angle Descriptions for a Four Stroke Engine

| | Piston | |
|---|---|---|
| Crank Angle (Degrees) | Position | Stroke Description |
| 360 | TDC | Between compression stroke |
| (−360) | | and expansion stroke. In some |
| | | literature, this crank angle is |
| | | referred to as “TDC |
| | | Combustion” |
| Between 360 and 540 | Transitioning | Expansion stroke |
| (Between −360 and −180) | from TDC to | |
| | BDC | |
| 540 | BDC | Between expansion stroke and |
| (−180) | | exhaust stroke |
| Between 540 and 720 | Transitioning | Exhaust stroke |
| (Between −180 and 0) | from BDC to | |
| | TDC | |
| 0 or 720 | TDC | Between exhaust stroke and |
| | | intake stroke. In some |
| | | literature, this crank angle is |
| | | referred to as “TDC gas |
| | | exchange” |
| Between 0 and 180 | Transitioning | Intake stroke |
| (Between −720 and −540) | from TDC to | |
| | BDC | |
| 180 | BDC | Between intake stroke and |
| (−540) | | compression stroke |
| Between 180 and 360 | Transitioning | Compression stroke |
| (Between −540 and −360) | from BDC to | |
| | TDC | |
| 360 | TDC | Between compression stroke |
| (−360) | | and expansion stroke. In some |
| | | literature, this crank angle is |
| | | referred to as “TDC |
| | | Combustion” |

In some embodiments, the term “immediately prior to ignition” or “just prior to ignition” can refer to a temporal point, at which the engine crank angle is about 300°, about 305°, about 310°, about 315°, about 320°, about 325°, about 330°, about 335°, about 340°, about 345°, about 350°, about 355°, about 360°, about 365°, about 370°, about 375°, or about 380°, inclusive of all values and ranges therebetween.

In some embodiments, the term “immediately prior to ignition” or “just prior to ignition” can refer to a temporal point of approximately 50 ins, approximately 40 ins, approximately 30 ins, approximately 20 ins, approximately 10 ins, approximately 5 ins, approximately 2 ins, or approximately 1 ms prior to ignition, inclusive of all values and ranges therebetween.

In some embodiments, the term “immediately prior to ignition” or “just prior to ignition” can refer to a temporal point preceding the time at which 500 of the fuel exothermicity is observed to have happened. In other words, the fuel can be considered to have ignited when a measurable deviation in pressure could be detected to indicate exothermic fuel oxidation is occurring.

In some embodiments, the term “immediately prior to ignition” or “just prior to ignition” can refer to a temporal point about 1 crank angle degree, about 2 crank angle degrees, about 3 crank angle degrees, about 4 crank angle degrees, about 5 crank angle degrees, about 6 crank angle degrees, about 7 crank angle degrees, about 8 crank angle degrees, about 9 crank angle degrees, about 10 crank angle degrees, about 11 crank angle degrees, about 12 crank angle degrees, about 13 crank angle degrees, about 14 crank angle degrees, about 15 crank angle degrees, about 16 crank angle degrees, about 17 crank angle degrees, about 18 crank angle degrees, about 19 crank angle degrees, or about 20 crank angle degrees prior to ignition, inclusive of all values and ranges therebetween.

In some embodiments, the term “immediately prior to ignition” or “just prior to ignition” can refer to a temporal point about 50 ms, about 40 ms, about 30 ms, about 20 ms, about 10 ms, about 5 ms, about 2 ms, or about 1 ms prior to ignition, inclusive of all values and ranges therebetween.

In some embodiments, the term “immediately prior to fuel injection” or “just prior to fuel injection” can refer to a temporal point about 1 crank angle degree, about 2 crank angle degrees, about 3 crank angle degrees, about 4 crank angle degrees, about 5 crank angle degrees, about 6 crank angle degrees, about 7 crank angle degrees, about 8 crank angle degrees, about 9 crank angle degrees, about 10 crank angle degrees, about 11 crank angle degrees, about 12 crank angle degrees, about 13 crank angle degrees, about 14 crank angle degrees, about 15 crank angle degrees, about 16 crank angle degrees, about 17 crank angle degrees, about 18 crank angle degrees, about 19 crank angle degrees, or about 20 crank angle degrees prior to fuel injection, inclusive of all values and ranges therebetween.

In some embodiments, the term “immediately prior to fuel injection” or “just prior to fuel injection” can refer to a temporal point about 50 ms, about 40 ms, about 30 ms, about 20 ms, about 10 ms, about 5 ms, about 2 ms, or about 1 ms prior to fuel injection, inclusive of all values and ranges therebetween.

In some embodiments, the term “valve closing” (e.g., “intake valve closing” or “exhaust valve closing”) can refer to a temporal point, wherein the valve becomes fully seated (i.e., 0 mm valve lift). In some embodiments, the term “valve opening” (e.g., “intake valve opening” or “exhaust valve opening”) can refer to a temporal point, wherein the valve becomes unseated (i.e., >0 mm lift).

As used herein, “throttling” can refer to deliberately reducing pressure from an inlet to an outlet of a flow stream.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

In some embodiments, the novel, high-temperature mixing-controlled strategy described herein can be implemented in an opposed piston engine. This could include 2 or more pistons configured to compress an inducted charge, the engine potentially having no cylinder head. This could be a two-four-or other number of stroke design.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of operating a compression ignition engine on small-molecule fuels, the method comprising:
moving a volume of air through a first flow path;
closing a first valve to restrict the volume air from entering a charge air cooler;
opening a second valve to guide all or part of the volume of air to a second flow path, the first flow path and/or the second flow path including a heating unit; and
moving the volume of air to an intake manifold.

2. The method of claim 1, further comprising:
applying heat via the heating unit to the volume of air while the volume of air moves through the second flow path.

3. The method of claim 1, further comprising:
merging the volume of air in the first flow path and the volume of air in the second flow path in a common flow path;
applying heat via the heating unit to the common flow path.

4. The method of claim 1, further comprising:
moving the exhaust gas through a turbocharger turbine to compress the volume of air.

5. The method of claim 1, further comprising:
moving the volume of air into a plurality of cylinders via the intake manifold; and
combusting a small-molecule fuel in the plurality of cylinders while the volume of air is inside the plurality of cylinders to form a volume of combustion product.

6. The method of claim 5, further comprising:
retaining the combustion product in the plurality of cylinders for a time period sufficient to raise a temperature of the combustion product to a temperature of at least about 300° C.

7. The method of claim 5, further comprising: recirculating exhaust gas from one or more cylinders from the plurality of cylinders back to at least one of the first flow path or the second flow path without flowing the exhaust gas through an exhaust gas recirculation (EGR) cooler based on threshold temperatures for exhaust gas and intake valve closing.

8. The method of claim 5, further comprising:
deactivating at least one cylinder of the plurality of cylinders, the deactivating including closing an intake valve, an exhaust valve, and discontinuing injection of fuel into the at least one cylinder.

9. The method of claim 5, further comprising:
increasing a load on the plurality of cylinders to increase a temperature within each of the cylinders.

10. The method of claim 9, wherein increasing the load on the plurality of cylinders increases the temperature within each of the cylinders at intake valve closing.

11. The method of claim 5, further comprising:
measuring a temperature of the volume of air as the volume of air enters the plurality of cylinders.

12. The method of claim 5, further comprising:
measuring a temperature of the volume of air at intake valve closing.

13. The method of claim 11, further comprising:
directing exhaust gas from the hottest cylinder from the plurality of cylinders to the intake manifold via an exhaust manifold.

14. The method of claim 1, further comprising:
moving the volume of air into a first cylinder from a plurality of cylinders while keeping the remaining cylinders from the plurality of cylinders in a deactivated state.

15. The method of claim 14, further comprising:
after the exhaust gas has reached a threshold temperature, activating the remaining cylinders from the plurality of cylinders.

16. The method of claim 1, further comprising:
opening an EGR valve;
substantially closing or restricting an exhaust passage; and
recirculating the volume of air without injecting fuel until the volume of air has reached a threshold temperature.

17. An engine, comprising
a first flow path;
a charge air cooler;
a first valve configured to allow, block, or restrict flow through a passage between the first flow path and an inlet of the charge air cooler;
a second flow path;
a second valve configured to allow, block, or restrict flow through a passage between the first flow path and the second flow path;
a third flow path configured to route flow from at least one of the first flow path or the second flow path to an intake manifold;
a plurality of cylinders;
an EGR valve configured to allow, block, or restrict flow through an exhaust path between the exhaust of the cylinders and the third flow path;
an intake manifold fluidically coupling the plurality of cylinders and the third flow path; and
a heating unit disposed at a location along at least one of the second flow path or the third flow path.

18. The engine of claim 17, further comprising:
a first EGR path including an EGR cooler, a second EGR path absent of an EGR cooler, and one or more valves configured to adjust the total amount of exhaust routed to the third flow path and the fraction of EGR that is cooled or uncooled.

19. The engine of claim 18, further comprising:
a temperature measurement device.

20. The engine of claim 19, wherein the temperature measurement device measures at least one of an intake manifold temperature in one or more of the cylinders, a temperature in a cylinder from the plurality of cylinders at intake valve closing, the first valve, the second valve, or the EGR valve to modulate cooling of air and/or exhaust to achieve a target temperature.

21.-25. (canceled)
